(19) United States
(12) Patent Application Publication
(10) Pub. No.: US 2016/0027564 A1
(43) Pub. Date: Jan. 28, 2016

(54) METHOD FOR PRODUCING RFeB SYSTEM SINTERED MAGNET AND RFeB SYSTEM SINTERED MAGNET PRODUCED BY THE SAME

(71) Applicant: INTERMETALLICS CO., LTD., Nakatsugawa-shi, Gifu (JP)

(72) Inventors: Yasuhiro UNE, Nagoya-shi (JP); Hirokazu KUBO, Kasugai-shi (JP); Masato SAGAWA, Kyoto-shi (JP); Satoshi SUGIMOTO, Sendai-shi (JP); Masashi MATSUURA, Sendai-shi (JP); Michihide NAKAMURA, Tokai-shi (JP)

(73) Assignee: INTERMETALLICS CO., LTD., Nakatsugawa-shi, Gifu (JP)

(21) Appl. No.: 14/773,877

(22) PCT Filed: Mar. 12, 2014
(86) PCT No.: PCT/JP2014/056396

§ 371 Date: Sep. 9, 2015

(30) Foreign Application Priority Data
Mar. 12, 2013 (JP) 2013-049618

(51) Int. Cl. H01F 1/057; B22F 3/10; B22F 9/04; H01F 41/02; C22C 38/00; C22C 38/16; C22C 38/06; C22C 38/10; C22C 33/02; B22F 9/02

(52) U.S. Cl. CPC H01F 1/0577; C22C 33/0207; B22F 3/10; B22F 9/04; B22F 9/023; C22C 38/005; C22C 38/002; C22C 38/16; C22C 38/06; C22C 38/10; H01F 41/0253

(57) ABSTRACT

A method for producing an RFeB system sintered magnet with the main phase grains having a grain size of 1 μm or less with a considerably equal grain size, including: preparing a shaped body oriented by a magnetic field and sintering the shaped body, wherein the shaped body is prepared using an alloy powder of an RFeB material having a particle size distribution with an average value of 1 μm or less in terms of a circle-equivalent diameter determined from a microscope image, the alloy powder obtained by pulverizing coarse particles having fine crystal grain, each coarse particle having grains of the RFeB material formed inside, the crystal grains having a crystal grain size distribution with an average value of 1 μm or less in terms of the circle-equivalent diameter determined from a microscope image, and 90% by area or more of the crystal grains being separated from each other.

### TECHNICAL FIELD

The present invention relates to a method for producing an RFeB system sintered magnet, such as a Nd₂Fe₁₄B system, as well as an RFeB system sintered magnet produced by this method (“R” represents any of the rare-earth elements, such as Nd, including Y; typically, such a system is expressed as R₂Fe₁₄B, although a slight variation in the ratio of R, Fe and B is allowed).

### BACKGROUND ART

An RFeB system sintered magnet is a permanent magnet produced by orienting and sintering a powder of RFeB alloy. RFeB system sintered magnets were discovered by Sagawa et al. in 1982. They have far better magnetic characteristics than those of conventional permanent magnets and have the advantage that they can be manufactured from rare-earth elements, iron and boron, which are all comparatively abundant and inexpensive materials.

It is expected that RFeB system sintered magnets will be increasingly in demand in the future as permanent magnets for motors used in hybrid cars and electric cars as well as for other applications. Automobiles must be designed for use under extreme loading conditions, and accordingly, their motors also need to be guaranteed to operate under high-temperature environments (e.g. 180° C.). Therefore, RFeB system sintered magnets which have a high level of coercivity that can suppress the decrease in magnetization (magnetic force) due to an increase in the temperature have been in demand.

For NdFeB system sintered magnets (R═Nd), the method of partially substituting Dy and/or Tb (which are hereinafter represented by R^{H}) for Nd in the magnet has conventionally been adopted to increase the coercivity. However, R^{H} are extremely rare elements, and furthermore, their production sites are considerably localized. Such a situation allows a producing country to intentionally stop the supply or increase the price, making it difficult to ensure a stable supply. There is also the problem that substituting R^{H} for Nd causes a decrease in the residual magnetic flux density of the sintered magnet.

One method for increasing the coercivity of the NdFeB system sintered magnet without using R^{H} is to reduce the size of the crystal grains which form the main phase (Nd₂Fe₁₄B) within the NdFeB system sintered magnet (Non Patent Literature 1; those crystal grains will be hereinafter called the “main phase grains”). It is commonly known that the coercivity of any kind of ferromagnetic material (or even ferrimagnetic material) can be increased by reducing the size of the internal crystal grains.

A conventional method for reducing the size of the main phase grains within the NdFeB system sintered magnet is to reduce the particle size of the alloy powder prepared as the raw material for the NdFeB system sintered magnet. However, it is difficult to achieve an average particle size of smaller than 3 μm by jet mill pulverization using nitrogen gas, which is a commonly used method for preparing an alloy powder.

One commonly known technique for reducing the crystal grain size is the HDDR method. In the HDDR method, a lump or coarse powder of RFeB alloy ranging from a few hundreds of μm to 20 mm in size (such a lump or coarse powder is hereinafter collectively called the “coarse powder”) is heated in a hydrogen atmosphere of 700-900° C. (“Hydrogenation”) to decompose the RFeB alloy into the three phases of RH₂ (a hydride of rare-earth R), Fe₂B and Fe (“Decomposition”), after which the atmosphere is changed from hydrogen to vacuum, while maintaining the temperature, to desorb hydrogen from the RH₂ phase (“Desorption”) and thereby cause a recombination reaction among the phases within each particle of the coarse powder of the raw material alloy (“Recombination”). As a result, a coarse particle in which RFeB phases (crystal grains) with an average size of 1 μm or less are formed is obtained (which is hereinafter called the “coarse particle having fine grain”). Such a treatment for forming a coarse particle having fine grain is hereinafter called the “fining treatment of grain in the coarse particle.” Patent Literature 1 discloses a method for producing a sintered magnet using a powder obtained by pulverizing coarse particles having fine grain after the HDDR treatment with a jet mill using nitrogen gas.

### CITATION LIST

### Patent Literature

Patent Literature 1: JP 2010-219499 A
Patent Literature 2: WO 2006/004014 A
Patent Literature 3: WO 2008/032426 A
Patent Literature 4: US 2010/0172783 A

### Non Patent Literature

Non Patent Literature 1: Yasuhiro Une and Masato Sagawa, “Enhancement of Coercivity of Nd—Fe—B Sintered Magnets by Grain Size Reduction”, J. Japan Inst. Metals, Vol. 76, No. 1 (2012), pp. 12-16, special issue on “Eikyuu Jishaku Zairyou No Genjou To Shourai Tenbou”
Non Patent Literature 2: Noriyuki Nozawa et al., “Microstructure and Coercivity of Fine-Grained Permanent Magnets Obtained by Rapid Hot Pressing of HDDR-Processed Nd—Fe—B Powder”, Hitachi Kinzoku Gihou (Hitachi Metals Technical Review), Vol. 27 (2011), pp. 34-41

### SUMMARY OF INVENTION

### Technical Problem

The coarse particle having fine grain obtained by the HDDR treatment of the coarse powder of the raw material alloy is a collectivity of crystal grain with a size of 100 μm to a few mm, with each internal crystal grain measuring 1 μm or less in size. Since each particle is a collectivity of crystal grain, the axes of orientation of the crystal grains after the normal HDDR process are not aligned but isotropic. An anisotropic collectivity has also been created by controlling the composition of the raw material alloy and/or the atmosphere during the HDDR treatment. However, the obtained particles significantly vary in the degree of orientation as compared to sintered magnets. Therefore, if a coarse powder of alloy after the HDDR treatment is pulverized with a jet mill using nitrogen gas and sintered according to the method described in Patent Literature 1, the following problems occur:

(1) Since it is difficult to pulverize particles to an average size of 3 μm or less, a considerable amount of polycrystalline particles with a size of several μm in the form of collectivity of crystal grain which has not been pulverized into single crystals will be mixed. Consequently, the particle size distribution will be broadened, including both fine particles to be sintered at low temperatures and coarse particles to be sintered at high temperatures, which prevents the liquid-phase sintering from being uniformly performed at optimum temperatures.

(2) Since the mixed polycrystalline particles are isotropic, the axes of orientation of the crystal grains within the polycrystalline particle cannot be aligned by an orientation treatment in a magnetic field. Even if an anisotropic material is used, the orientation will be less uniform than in the case of a conventional sintered magnet produced from a powder obtained by jet mill pulverization without the HDDR treatment.

(3) The mixture of fine singlecrystalline particles (a particle consisting of a single crystal) and larger polycrystalline particles makes the structure of the rare-earth rich phase (which contributes to the liquid-phase sintering) non-uniform. Therefore, the liquid-phase sintering will occur non-uniformly and cause problems, such as a decrease in the sintered density and an abnormal grain growth. Furthermore, the coercivity may be decreased due to a poor dispersion of the rare-earth rich phase within the sintered magnet.

A technique for enhancing the degree of orientation by compacting an HDDR-treated powder by a hot-pressing method has also been explored (Non Patent Literature 2). However, this technique has problems, such as low productivity and poorer magnetic properties as compared to sintered magnets.

The problem to be solved by the present invention is to provide a method for producing, with a high degree of orientation, an RFeB system sintered magnet with the main phase grains having approximately equal grain sizes with an average size of 1 μM or less.

### Solution to Problem

A method for producing an RFeB system sintered magnet according to the present invention developed for solving the previously described problem includes the steps of preparing a shaped body oriented by a magnetic field and sintering the shaped body, wherein the shaped body is prepared using an alloy powder of an RFeB material having a particle size distribution with an average value of 1 μm or less in terms of a circle-equivalent diameter determined from a microscope image, the alloy powder obtained by pulverizing coarse particles having fine crystal grain, each coarse particle having crystal grains of the RFeB material formed inside, the crystal grains having a crystal grain size distribution with an average value of 1 μm or less in terms of the circle-equivalent diameter determined from a microscope image, and 90% by area or more of the crystal grains being separated from each other.

The “circle-equivalent diameter” is the diameter D of a circle having an area equal to the area value S determined for each particle of the alloy powder by an analysis of an image (microscope image) obtained with an electron microscope or similar microscope, i.e. D=2×(S/π)^{0.5}. The “90% by area or more” means the ratio of the area of all the singlecrystalline particles to that of the entire powder composed of monocrystalline and polycrystalline particles. When the circle-equivalent diameter and/or the area ratio is calculated with a certain tolerance (error), if this tolerance is overlapped with the aforementioned range, the result falls within the scope of the present invention.

To “prepare a shaped body” means preparing an object whose shape is identical or approximate to that of the final product using an alloy powder of an RFeB material (this object is called the “shaped body”). The shaped body may be a compact produced by pressing an amount of alloy powder of an RFeB material into a shape identical or approximate to that of the final product, or it may be an amount of alloy powder of an RFeB material placed (without being pressed) in a container (mold) having a cavity whose shape is identical or approximate to that of the final product (see Patent Literature 2).

In the case where the shaped body is a press-molded compact, the “shaped body oriented” may be obtained from an alloy powder of an RFeB material by any of the following procedures: by molding the alloy powder and subsequently orienting it, by orienting the alloy powder and subsequently molding it, or by simultaneously orienting and molding an alloy powder.

In the case where the shaped body is an amount of alloy powder of an RFeB material placed in a mold without being pressed, it is preferable to sinter the shaped body (i.e. the alloy powder of the RFeB material in the mold) without applying a mechanical pressure to it. By omitting the application of the mechanical pressure to the alloy powder of the RFeB material from the process of preparing and sintering the shaped body, it is possible to obtain an RFeB system sintered magnet which does not only have high coercivity but also high maximum energy product since omitting the pressure application facilitates the handling of an alloy powder of an RFeB material with a small particle size (see Patent Literature 2).

In the method for producing a sintered magnet according to the present invention, the coarse particles having fine grain after the fining treatment of grain in the coarse particle are pulverized to 1 μm or less which is equal to the average size of the fine crystal grains formed in the individual particles, so that the largest portion of the coarse particles (90% by area or more on a microscope image) will be singlecrystalline particles. By orienting the thereby obtained alloy powder by a magnetic field, an RFeB system sintered magnet with main phase grains having an average size of 1 μm or less and a high degree of orientation can be produced. Furthermore, in the present invention, since the decrease in the percentage of the non-pulverized polycrystalline particles makes the particle size distribution narrower, a liquid-phase sintering with a high degree of uniformity can be performed.

The alloy powder of the RFeB material having the previously described characteristics can be obtained by treating a coarse powder of the raw material alloy by an HDDR method (grain-fining treatment) to produce coarse particles having fine grain, pulverizing the coarse particles having fine grain by a hydrogen pulverization method, and further pulverizing the particles by a jet mill method using helium gas.

The HDDR method does not only make the crystal grains in the raw material alloy become finer grains of equal size, but also allows the rare-earth rich phase to be dispersed with a high degree of uniformity through the intergranular regions among the fine grains in the recombination reaction. This helps pulverizing polycrystalline particles into singlecrystalline particles in the hydrogen pulverization and the jet-mill grinding, so that a powder having a uniform particle size with an average size of 1 μm or less can be obtained. The highly uniform dispersion of the rare-earth rich phase occurs in both the coarse particles having fine grain and the alloy powder of the RFeB material obtained by pulverizing those particles, so that the sintered magnet produced from this alloy powder of the RFeB material will also have the rare-earth rich phase dispersed with a high degree of uniformity among the main phase grains. The rare-earth rich phase existing between the main phase grains weakens the magnetic connection between the main phase grains. Therefore, even if some of the main phase grains undergo a magnetic field reversal due to a reverse magnetic field applied to the entire magnet, the rare-earth rich phase residing between the main phase grains impedes the propagation of the magnetic field reversal to the neighboring grains. Thus, the coercivity of the sintered magnet is enhanced.

Although the coarse powder of the raw material alloy before being treated by the HDDR method may be a coarse powder of an alloy produced by a strip casting method (“strip-cast” alloy), it is more preferable to use a coarse powder of an alloy produced by a melt spinning method (which is hereinafter called the “melt-spinning alloy”). The strip casting method is a technique in which a molten metal of the raw material alloy is poured onto the surface of a rotating object (such as a roller or disk) to rapidly cool the molten metal. In the melt spinning method, the molten metal is spouted from a nozzle onto the rotating object and thereby cooled more rapidly (“ultraquenching”) than in the strip casting method. The strip-cast alloy has crystal grains with a size of a few tens of μm or greater among which the rare-earth rich phase shaped like lamellae (thin plates) is formed with a spacing of 4-5 μm, while the melt-spinning alloy has crystal grains ranging from 10 nm to a few μm in size, with the rare-earth rich phase uniformly dispersed filling the spaces between the crystal grains. Such a difference in the form of the rare-earth rich phase affects the HDDR treatment as follows: If the HDDR treatment is performed on a strip-cast alloy, the rare-earth rich phase cannot penetrate into the intergranular regions among the main phase grains near the center of the space between the neighboring lamellae, so that the dispersion of the rare-earth rich phase becomes incomplete, with some of the crystal grains left in the bare form while others surrounded by the rare-earth rich phase. By contrast, if the HDDR treatment is performed on a melt-spinning alloy, a coarse particle having fine grain with the rare-earth rich phase uniformly and finely dispersed through the intergranular regions among the grains can be obtained. By finely pulverizing such coarse particles having fine grain and using the obtained alloy powder as the raw material, it is possible to produce an RFeB system sintered magnet in which the rare-earth rich phase exists with a high degree of uniformity between the main phase grains.

By the method for producing an RFeB system sintered magnet according to the present invention, an RFeB system sintered magnet with the main-phase grains having an average size of 1 μm or less and a degree of orientation of 95% or higher can be produced.

### Advantageous Effects of the Invention

In the method for producing an RFeB system sintered magnet according to the present invention, coarse particles having fine grain obtained by performing a grain-fining treatment (e.g. an HDDR process) on a coarse powder of a raw material alloy are pulverized so that the fine grains formed in the individual coarse particles will be separated from each other into singlecrystalline particles. These particles are subsequently oriented by a magnetic field and sintered, whereby an RFeB system sintered magnet with the main phase grains having an average size of 1 μm or less can be obtained with a high degree of orientation and approximately equal grain sizes. Such a magnet cannot be obtained by the combination of the conventional grain-refining treatment and the jet mill pulverization using nitrogen gas.

### BRIEF DESCRIPTION OF DRAWINGS

FIG. 1 is a chart showing the process flow in one example of a method for producing a sintered magnet according to the present invention.

FIGS. 2A-2D are backscattered electron images taken at polished surfaces of a lump of a strip-cast alloy used in the present example.

FIG. 3 is a graph showing a temperature history and pressure history during an HDDR process in the present example.

FIG. 4A is a secondary electron image of a coarse powder after HDDR in the present example, and FIG. 4B is a particle size distribution of this coarse powder after HDDR.

FIG. 5A is a secondary electron image of an alloy powder (Present Example 1) obtained by helium jet mill pulverization of the coarse powder after HDDR in the present example, and FIG. 5B is a particle size distribution of this alloy powder.

FIG. 6A is a secondary electron image of an alloy powder (Present Example 2) obtained by helium jet mill pulverization of the coarse powder after HDDR in the present example, and FIG. 6B is a particle size distribution of this alloy powder.

FIG. 7A is a secondary electron image of another lot of coarse powder after HDDR, and FIG. 7B is a particle size distribution of this coarse powder after HDDR.

FIG. 8A is a secondary electron image of an alloy powder (Comparative Example 1) obtained by performing helium jet mill pulverization of the coarse powder after HDDR at a throughput four times as high as the present example, and FIG. 8B is a particle size distribution of this alloy powder.

FIG. 9A is a secondary electron image of an alloy powder (Comparative Example 2) produced without using an HDDR coarse powder, and FIG. 9B is a particle size distribution of this alloy powder.

FIGS. 10A-10D are secondary electron images of the four kinds of alloy powder.

FIG. 11 is a graph of the magnetization curve of NdFeB system sintered magnets of the present and comparative examples.

FIGS. 12A-12D are backscattered electron images showing sectional surfaces including the axes of orientation of the NdFeB system sintered magnets of the present and comparative examples.

FIGS. 13A-13D are secondary electron images taken at fracture surfaces perpendicular to the pole faces of the NdFeB system sintered magnets of the present and comparative examples.

FIG. 14A-14D are graphs showing the grain size distributions of the main phase grains of the NdFeB system sintered magnets of the present and comparative examples.

FIG. 15 is a backscattered electron image taken at a fracture surface of a lump of melt-spinning (MS) alloy used in the present example.

FIG. 16A is a backscattered electron image taken at a fracture surface of a lump of alloy after HDDR obtained in the present example by performing an HDDR treatment on the lump of MS alloy, and FIG. 16B is a grain size distribution of the particles of the lump of alloy after HDDR, determined by analyzing that image.

FIGS. 17A and 17B are backscattered electron images taken at a polished sectional surface of a lump of alloy after HDDR on a lump of MS alloy, and FIG. 17C is a backscattered electron image taken at a polished sectional surface of a lump of alloy after HDDR on a lump of SC alloy.

FIG. 18A is a secondary electron image of a coarse powder after HDDR obtained by a hydrogen pulverization and jet-mill grinding of a lump of alloy after HDDR on a lump of MS alloy, and FIG. 18B is a particle size distribution of the alloy powder.

FIG. 19 shows secondary electron images taken at a fracture surface of a sintered magnet produced from a coarse powder after HDDR on a lump of MS alloy.

FIG. 20 shows secondary electron images taken at a polished sectional surface of a sintered magnet produced from a coarse powder after HDDR on a lump of MS alloy.

FIG. 21A is a secondary electron image taken at a fracture surface of a sintered magnet produced from a coarse powder after HDDR on a lump of MS alloy, and FIG. 21B is a crystal grain size distribution of the main phase grains.

### DESCRIPTION OF EMBODIMENTS

An example of a method for producing a sintered magnet according to the present invention is hereinafter described with reference to the drawings.

### Example

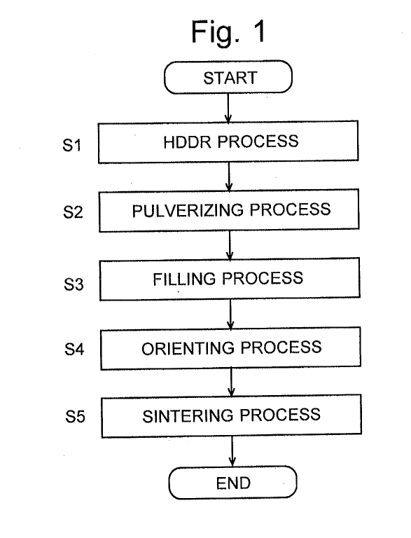

As shown in FIG. 1, the method for producing a sintered magnet according to the present example has five processes: the HDDR process (Step S1), pulverizing process (Step S2), filling process (Step S3), orienting process (Step S4) and sintering process (Step S5). Each of these processes will be hereinafter described.

Initially, a coarse powder of the raw material alloy was prepared using a lump of strip-cast (SC) alloy having the composition as shown in Table 1 (this powder is hereinafter called the “coarse powder of SC alloy”).

TABLE 1
Composition of Coarse Powder of Raw
Material Alloy (SC Alloy) Used in Present Example

| Nd | Pr | B | Cu | Al | Co | Fe |
|---|---|---|---|---|---|---|
| 26.35 | 4.07 | 1.00 | 0.10 | 0.28 | 0.92 | bal. |

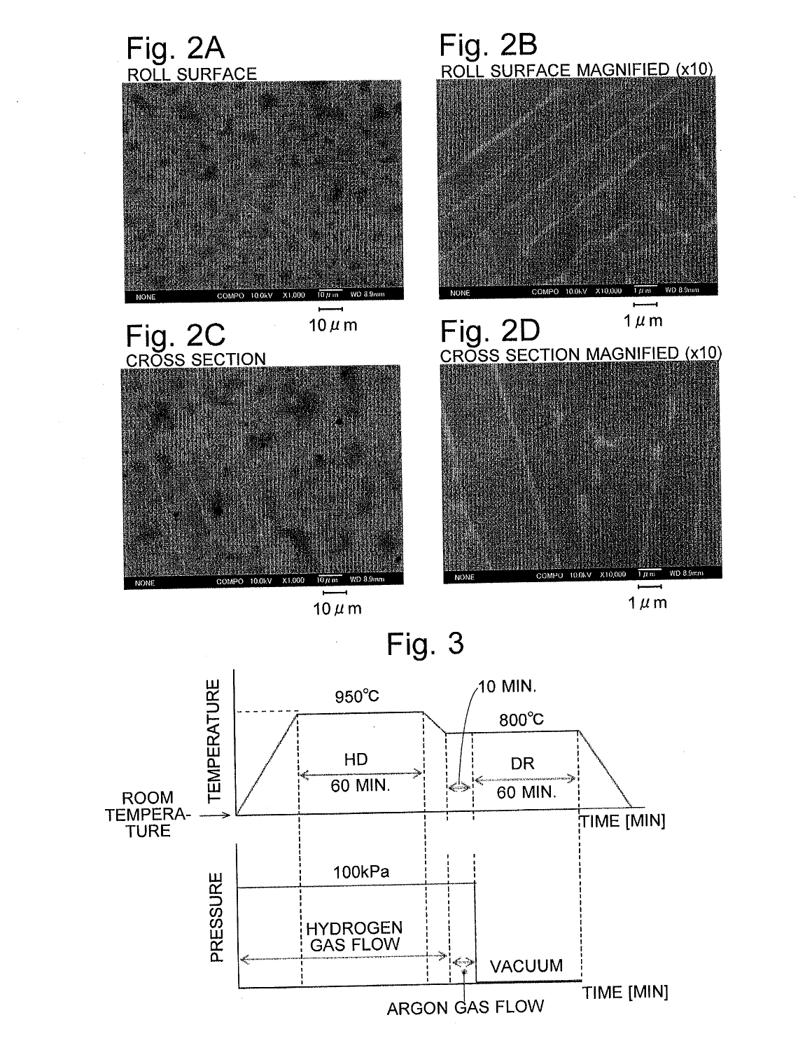

FIGS. 2A-2D show backscattered electron (BSE) images of the particles of this coarse powder of SC alloy. Three phases with different levels of brightness can be seen in the images of FIGS. 2A-2D. Among those three phases, the white portions correspond to the rare-earth rich phase containing a higher amount of rare earth than the main phase (R₂Fe₁₄B) in the alloy particle.

The oxygen content of this coarse powder of alloy was 88±9 ppm, and the nitrogen content was 25±8 ppm.

In advance of the HDDR process, the coarse powder of SC alloy of FIGS. 2A-2D is exposed to hydrogen gas to make the coarse powder of SC alloy occlude hydrogen atoms. In this process, although some portion of the hydrogen atoms are occluded in the main phase, most of the atoms are occluded in the rare-earth rich phase. The hydrogen which is in this way mainly occluded in the rare-earth rich phase causes the rare-earth rich phase to expand and make the coarse powder of SC alloy brittle.

FIG. 3 is a graph showing a temperature history and pressure history during the HDDR process. In the HDDR process of the present example, the aforementioned coarse powder of SC alloy was heated at 950° C. for 60 minutes in hydrogen atmosphere of 100 kPa to decompose the Nd₂Fe₁₄B compound (main phase) in the coarse powder of SC alloy into the three phases of NdH₂, Fe₂B and Fe (Decomposition: “HD” in the figure). Next, with the hydrogen atmosphere maintained, the temperature was decreased to 800° C., after which argon gas was supplied for 10 minutes, with the temperature maintained at 800° C. Subsequently, the atmosphere was changed to vacuum, and the temperature was maintained at 800° C. for 60 minutes to desorb hydrogen from the NdH₂ phase and cause a recombination reaction of the Fe₂B and Fe phases (Desorption and Recombination: “DR” in the figure). By performing such an HDDR treatment on the coarse powder of SC alloy, coarse particles having fine grain (which are polycrystalline particles) are obtained. It should be noted that the purpose of decreasing the temperature from 950° C. to 800° C. after the HD treatment in the present HDDR process is to prevent the growth of fine grains formed by the DR process.

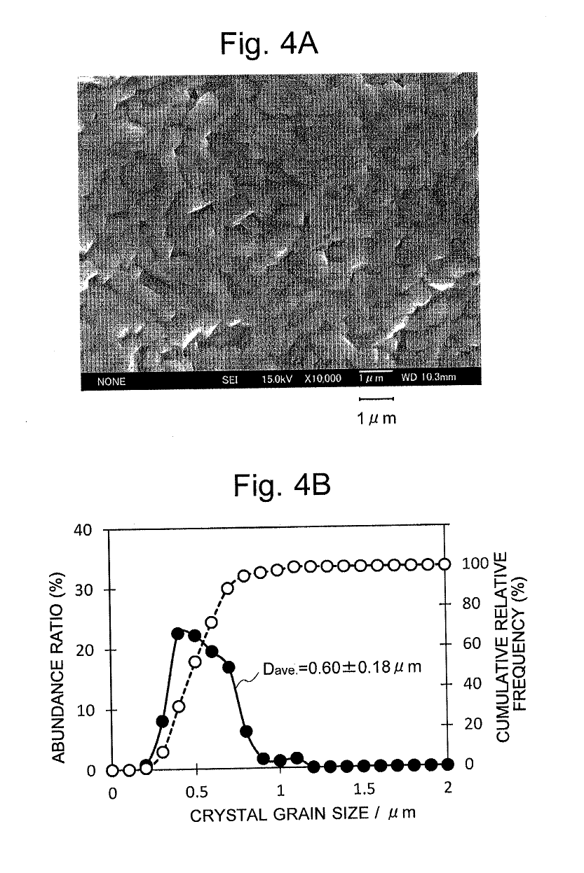

FIG. 4A is a secondary electron image (SEI) of a coarse particle having fine grain obtained by performing the HDDR treatment of FIG. 3 on the coarse powder of SC alloy of FIGS. 2A-2D. FIG. 4B shows a crystal grain size distribution obtained by extracting the contour line of each crystal grain on the SEI image, determining the area value S of the portion surrounded by the contour line for each crystal grain, and calculating the diameter D of a circle corresponding to the area value S (the circle-equivalent diameter: D=2×(S/π)^{0.5}). The annotation “Dₐᵥₑ=0.60±0.18 μm” in the figure means that the average crystal grain size is 0.60 μm and the standard deviation is 0.18 μm.

In the pulverizing process, a collectivity (powder) of coarse particles having fine grain is exposed to hydrogen gas to make the coarse particles having fine grain occlude hydrogen and become brittle. Next, they are coarsely pulverized with a mechanical crusher, and an organic lubricant is added and mixed as a grinding aid. The obtained coarse powder (which is hereinafter called the “coarse powder after HDDR”) is introduced into a complete jet mill plant with helium gas circulation system (manufactured by Nippon Pneumatic Mfg. Co., Ltd., which is hereinafter called the “helium jet mill”) to further pulverize the coarse powder after HDDR. A stream of helium gas can flow approximately three times as fast as that of nitrogen gas. The fast flow of gas makes the raw material move at high speeds and repeat collisions, whereby the particles can be pulverized to an average size of 1 μm or less, a level which cannot be achieved by conventional jet mills using nitrogen gas. After the coarse powder after HDDR is pulverized in this manner, an organic lubricant is added and mixed. This lubricant reduces frictions between the particles of the fine powder and helps them fill a mold with high density or be oriented by a magnetic field.

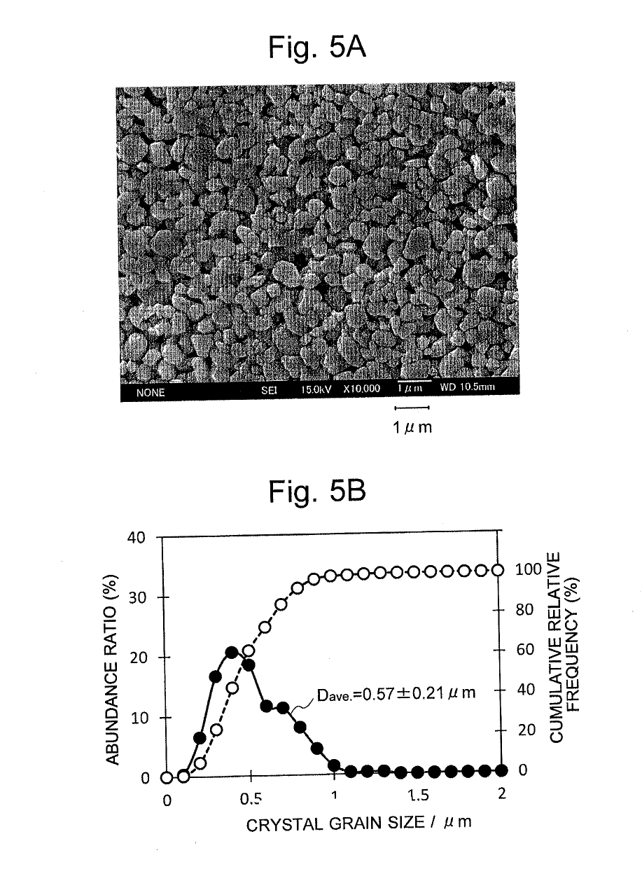

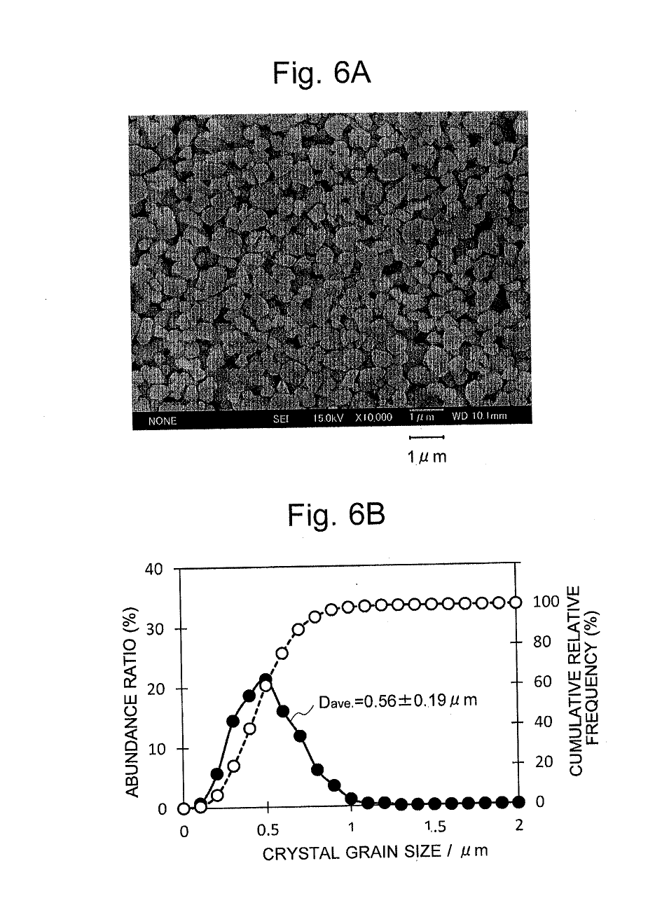

FIG. 5A is an SEI image of an alloy powder obtained by making this coarse powder after HDDR occlude a sufficient amount of hydrogen at room temperature and subsequently introducing it into the helium jet mill with a pulverizing pressure of 0.7 MPa. A comparison between FIGS. 4A and 5A shows that the crystal grains in FIG. 4A are not separated from each other, while those in FIG. 5A are separated from each other. FIG. 5B is a graph of the crystal grain size distribution showing the circle-equivalent diameter of the crystal grains in the SEI image of FIG. 5A (FIGS. 6B-9B, which will be described later, also show similar crystal grain size distributions). The average value and standard deviation of the crystal grain size distribution in FIG. 5B are 0.57 μm and 0.21 μM, respectively. In this alloy powder, the percentage of the non-pulverized polycrystalline particles, i.e. the particles which had undergone the pulverizing process yet could not be pulverized to singlecrystalline particles, was 10% by area. This alloy powder of FIGS. 5A and 5B is hereinafter called the “alloy powder of Present Example 1.”

FIG. 6A is an SEI image of an alloy powder obtained by making the coarse powder after HDDR of FIGS. 4A and 4B occlude hydrogen at 200° C. for five hours and subsequently introducing it into the helium jet mill with a pulverizing pressure of 0.7 MPa, and FIG. 6B is the crystal grain size distribution of the obtained powder. The average value and standard deviation of the distribution are 0.56 μm and 0.19 μm, respectively. The percentage of the non-pulverized polycrystalline particles in this powder was 3% by area. This alloy powder of FIGS. 6A and 6B is hereinafter called the “alloy powder of Present Example 2.” In the alloy powder of Present Example 2, the percentage of the crystal grains of 0.8 μm or greater in size was lower than in the alloy powder of Present Example 1. This fact demonstrates that the powder was pulverized to even smaller sizes. That is to say, the hydrogen pulverization performed at 200° C. produced a higher pulverizing performance than Present Example 1 in which the hydrogen pulverization was performed at room temperature.

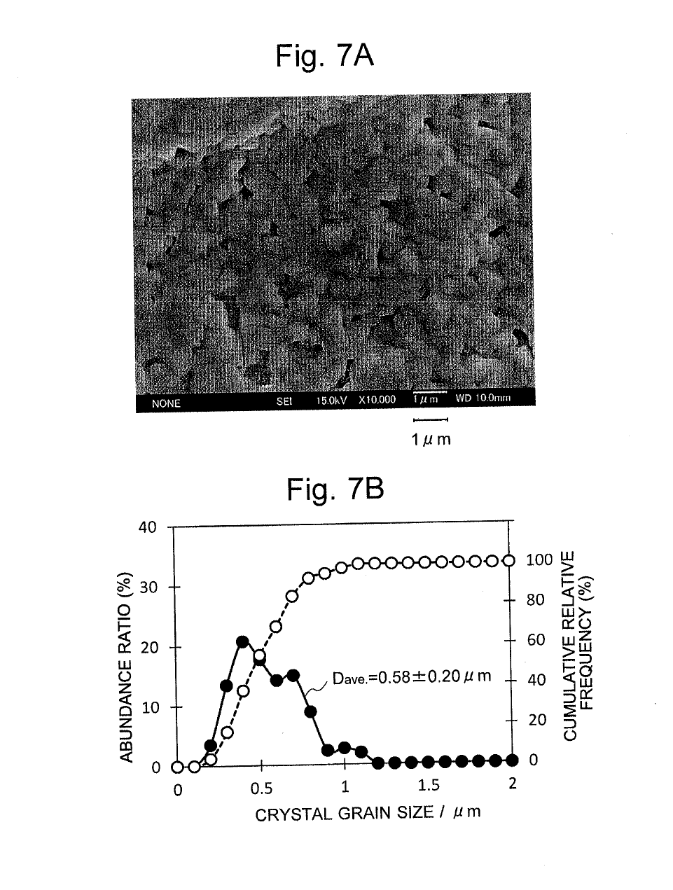

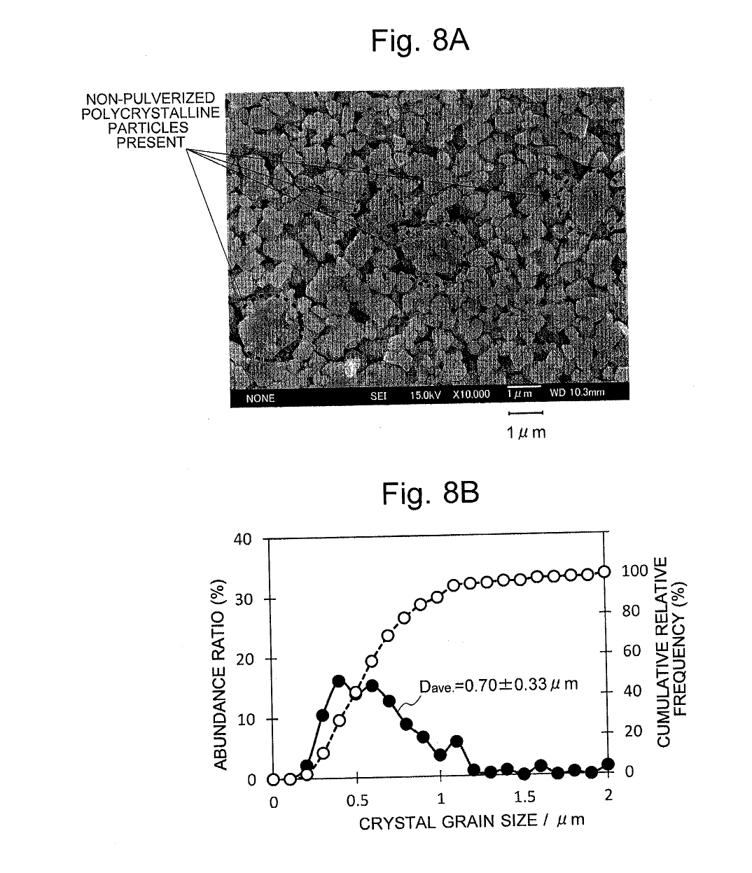

Next, as the first comparative example, an alloy powder was produced from another lot of coarse powder after HDDR (FIGS. 7A and 7B) which had been subjected to the HDDR treatment, by making this powder occlude hydrogen at room temperature and subsequently introducing it into the helium jet mill with a pulverizing pressure of 0.7 MPa so that the powder would pass through the jet mill at a throughput four times as high as the first and second present examples. FIG. 8A is an SEI image of this alloy powder, and FIG. 8B is its crystal grain size distribution. The average value and standard deviation of this crystal grain size distribution are 0.70 μm and 0.33 μm, respectively.

In the alloy powder of FIG. 8A, as can be seen in the portions surrounded by the broken lines, a greater amount of non-pulverized polycrystalline particles remain than in the first and second present examples. The percentage of the non-pulverized polycrystalline particles in this alloy powder was 30%. This alloy powder of FIGS. 8A and 8B is hereinafter called the “alloy powder of Comparative Example 1.”

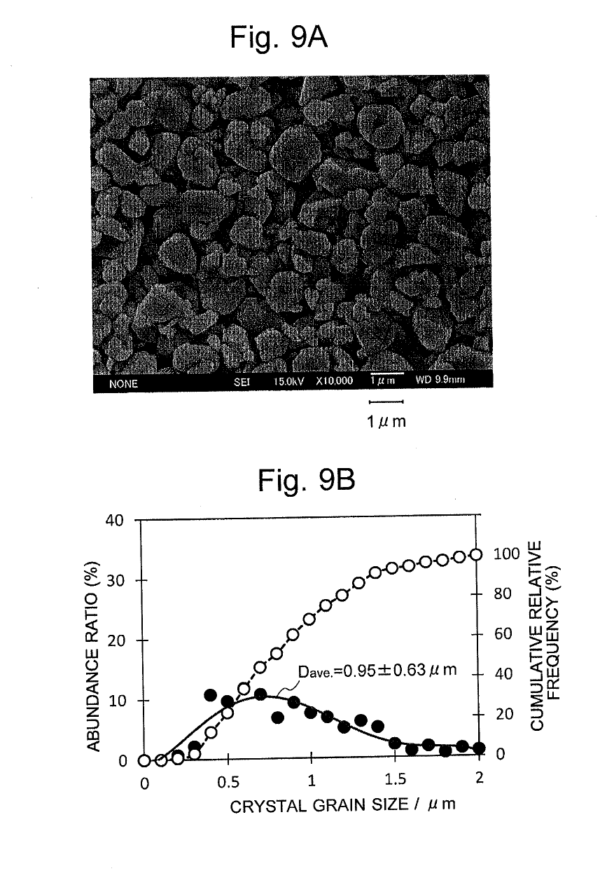

Still another alloy powder was produced as the second comparative example by performing only the hydrogen pulverization and helium jet milling, without the HDDR process. FIGS. 9A and 9B show the result. This alloy powder was obtained by making a coarse powder of SC alloy occlude hydrogen at room temperature, crushing the powder into coarse powder with an average particle size of hundreds of μm, and finely pulverizing it to smaller sizes by the helium jet mill with a pulverizing pressure of 0.7 MPa under the same conditions as used in the first and second present examples. FIG. 9A is an SEI image of this alloy powder, and FIG. 9B is its crystal grain size distribution. The average value and standard deviation of this crystal grain size distribution are 0.95 μm and 0.63 μm, respectively. This alloy powder is hereinafter called the “alloy powder of Comparative Example 2.”

If the alloy powder is produced by performing only the hydrogen pulverization and the helium jet milling while bypassing the HDDR process, the crystal grain size distribution will be significantly broadened, as shown in FIG. 9B. In other words, the alloy powder will be a mixture of alloy powder particles which greatly vary in size including both large and small particles (FIG. 9A).

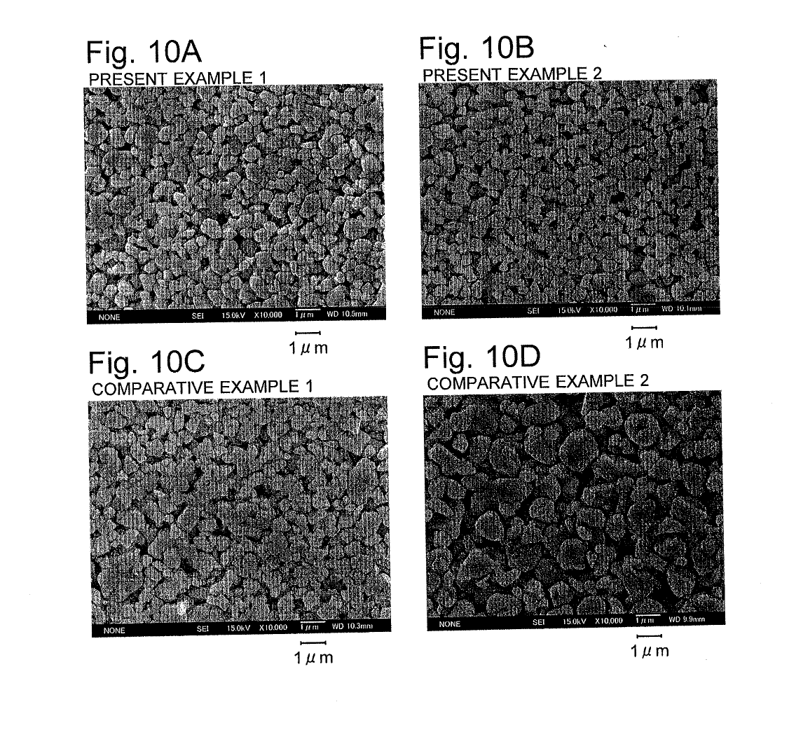

FIGS. 10A-10D show a comparison of the SEI images of the alloy powders of Present Examples 1 and 2 as well as Comparative Examples 1 and 2. The direct comparison of those SEI images demonstrates that the particles of the alloy powders of Present Examples 1 and 2 are approximately uniform and smaller in size than those of the alloy powders of Comparative Examples 1 and 2.

A NdFeB system sintered magnet was produced from each of the alloy powders of Present Example 1, Present Example 2 and Comparative Example 1 prepared from the coarse powder after HDDR. The procedure was as follows: Initially, an organic lubricant was mixed in each alloy powder. The alloy powder was placed in a cavity of a predetermined mold at a filling density of 3.6 g/cm³ (filling process). With no mechanical pressure applied to the alloy powder in the cavity, a pulsed AC magnetic field of approximately 5 tesla was applied two times, followed by a pulsed DC magnetic field which was applied one time (orienting process). The thereby oriented alloy powder was placed within a sintering furnace together with the mold, after which the alloy powder, with no mechanical pressure applied, was sintered by being heated in vacuum at 880° C. for two hours (sintering process). The obtained sintered body was machined to create a cylindrical sintered magnet measuring 9.8 mm in diameter and 6.5 mm in length.

Table 2 shows the magnetic properties of the NdFeB system sintered magnets produced from the three kinds of alloy powders.

TABLE 2
Magnetic Properties of NdFeB System Sintered Magnets
of Present and Comparative Examples

| | Hcj | Br/Js | HK | SQ |
|---|---|---|---|---|
| | kOe | % | kOe | % |
| Present Example 1 | 12.0 | 95.2 | 10.8 | 90.3 |
| Present Example 2 | 12.1 | 95.4 | 11.3 | 93.4 |
| Comparative Example 1 | 11.8 | 94.4 | 10.9 | 92.2 |

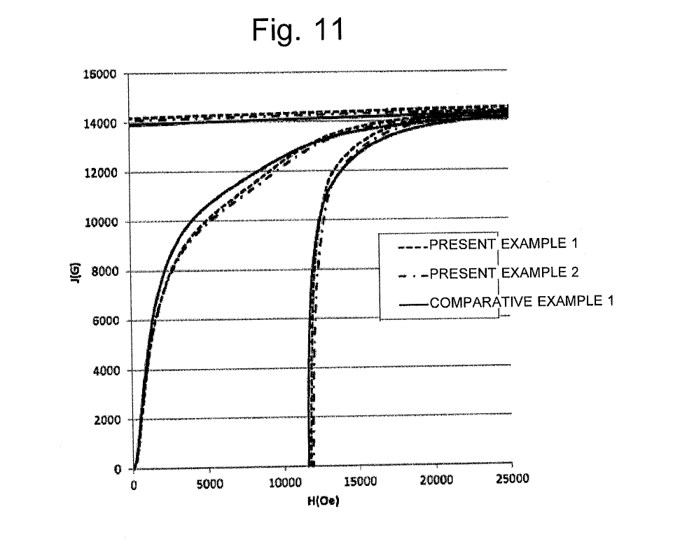

Those magnetic properties were measured with a pulse BH curve tracer (manufactured by Nihon Denji Sokki Co., Ltd.) In this table, H_{cJ} is the coercivity, Bᵣ/Jₛ is the degree of orientation, H_{K} is the absolute value of the magnetic field when the magnetization is decreased from the remnant magnetization by 10%, and SQ is the squareness ratio (which equals H_{K} divided by H_{cj}). Greater values of those data mean that better magnet properties have been obtained. Additionally, FIG. 11 shows the first quadrant of the graph of the magnetization curve (J-H curve) measured with the pulse BH tracer.

As can be seen in Table 2 and the graph of FIG. 11, the sintered magnets of Present Examples 1 and 2 had high degrees of orientation Bᵣ/Jₛ which exceeded 95%. By contrast, the degree of orientation Bᵣ/Jₛ of the sintered magnet produced from the alloy powder of Comparative Example 1 (which is hereinafter called the “sintered magnet of Comparative Example 1”) was less than 95%. This is because a high amount (exceeding 10%) of non-pulverized polycrystalline particles remained. Thus, it was found that the area ratio (proportion) of the non-pulverized polycrystalline particles must be decreased in order to achieve a high degree of orientation Bᵣ/Jₛ.

A comparison of Present Examples 1 and 2 show that Present Example 2 had a higher squareness ratio SQ. A probable reason is that the hydrogen pulverization in the fine pulverization process was not performed at room temperature but at higher temperatures.

When the heating temperature is lower than 100° C., the hydrogen is occluded in both the main phase and the rare-earth rich phase, causing both phases to considerably expand. Therefore, the strain between the main phase and the rare-earth rich phase is unlikely to develop, so that cracks are hardly formed. On the other hand, when the heating temperature exceeds 300° C., the rare-earth rich phase forms a structure of RH₂ and occludes a lower amount of hydrogen. Therefore, the strain between the main phase and the rare-earth rich phase is likely to decrease. A heating time of less than one hour will produce an insufficient effect, while a heating time of over ten hours is unfavorable for production. Due to those reasons, the heating temperature in the hydrogen pulverization process should preferably be within a range of 100-300° C. and the heating time between 1-10 hours.

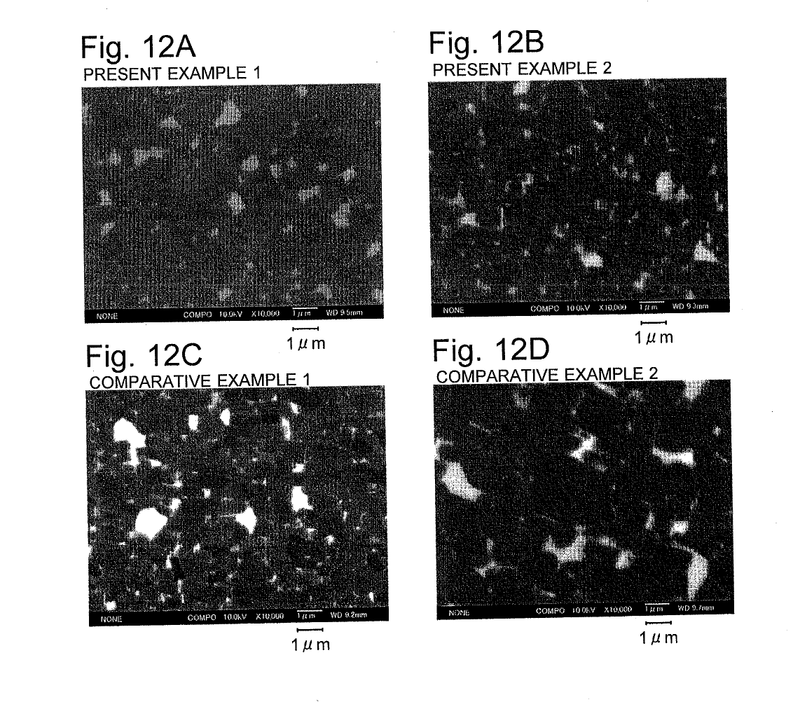

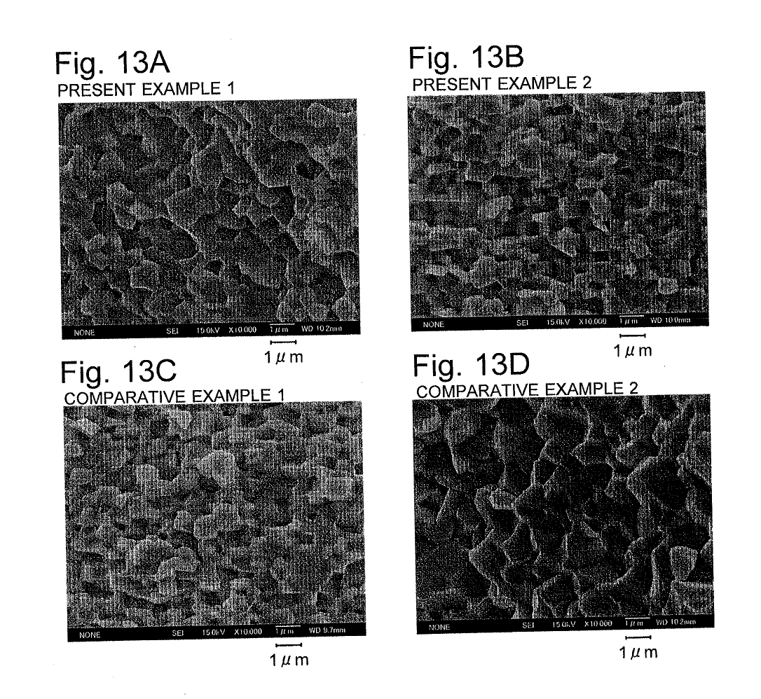

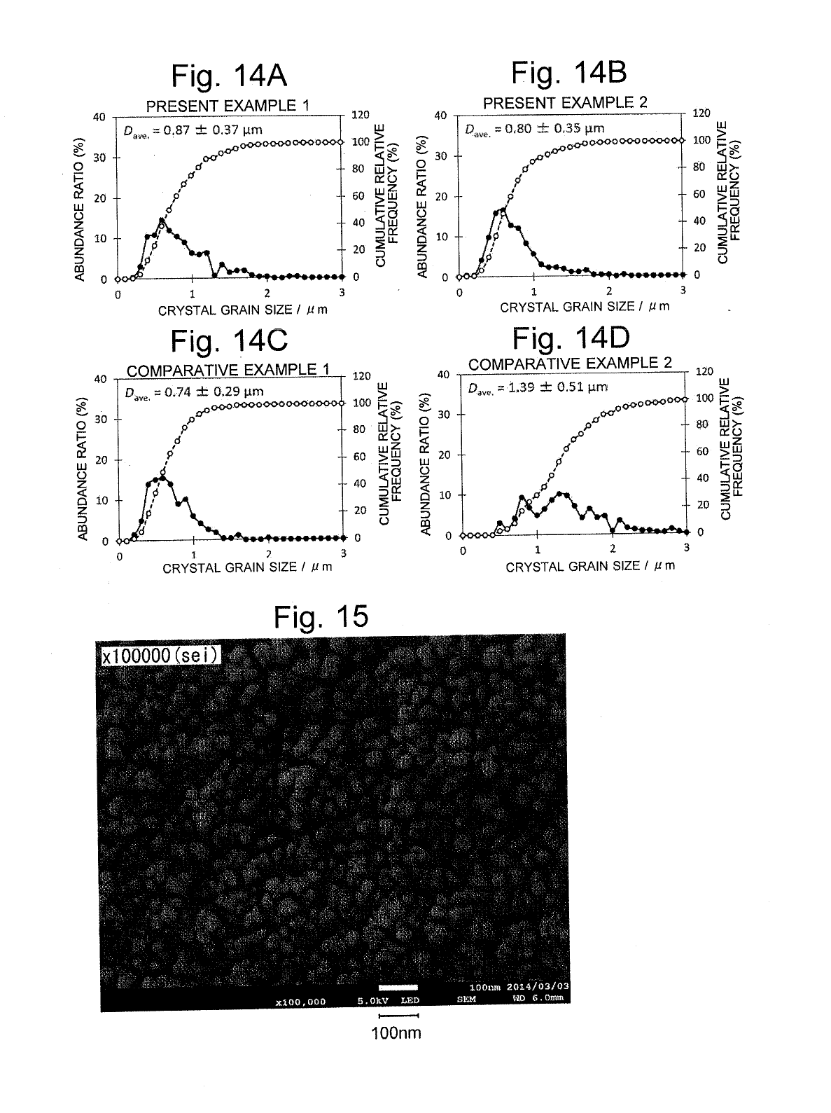

FIGS. 12A-12D are BSE images showing sectional surfaces including the axes of orientation of the three kinds of sintered magnets and a sintered magnet produced from the alloy powder of Comparative Example 2. FIGS. 13A-13D are SEI images of fracture surfaces observed when the four kinds of sintered magnets were broken perpendicularly to the pole faces (circular faces). FIGS. 14A-14D are graphs showing the crystal grain size distributions showing the circle-equivalent diameter of the main phase grains in the sintered magnets obtained from the SEI images of the fracture surfaces by an image processing. The white portions in FIGS. 12A-12D are rare-earth (Nd) rich phases.

From FIGS. 12A-12D, it is possible to conclude that the main phase grains in the present examples have characteristically low degrees of flatness, as will be hereinafter described.

With a denoting the length of the longest axis of a section of a crystal grain including the axis of orientation and b denoting the length of an axis perpendicular to that axis, the degree of flatness is expressed as b/a. A smaller value of this ratio means the crystal grain being more flattened. Under the condition that the grain size is the same, a b/a value closer to one means a smaller specific surface area and a smaller crystal grain boundary, which has the advantage that a smaller amount of rare-earth rich phase is required. Another merit is that, when heavy rare-earth elements (Dy, Tb) are diffused through the crystal grain boundaries to increase the coercivity (for example, see Patent Literature 3), the diffusion path will be shortened.

The b/a value calculated from FIGS. 12A-12D was 0.65±0.17 (0.48-0.82) for Present Example 1 and 0.62±0.17 (0.45-0.79) for Present Example 2. On the other hand, a hot-plastic-deformed magnet described in Patent Literature 4, which is known as a magnet that can be produced with a small grain size, has a b/a value of 0.23±0.08 as estimated from FIG. 9 of the literature. This difference results from the fact that the main phase grains in the hot-plastic-deformed magnet are deformed into a flat shape parallel to the axis of orientation due to a stress applied to the crystal grains to improve the degree of orientation, while the present invention does not require such an application of the stress. Thus, according to the present embodiment, a NdFeB system magnet having a lower degree of flatness than the hot-plastic-deformed magnet can be obtained.

The grain size distributions of FIGS. 14A-14D show that a fine, uniform microstructure with the main phase grains having an average size of 1 μm or less and a standard deviation of 0.4 μm or less was obtained in any of the sintered magnets of Present Examples 1 and 2 as well as Comparative Example 1. By contrast, in the result obtained for the sintered magnet of Comparative Example 2, the grain size distribution was more broadened, with the main phase grains having an average size of 1.39 μM and a standard deviation of 0.51 μm. These results prove that the method in which a coarse powder having fine grains formed by the HDDR process is made to occlude hydrogen and be pulverized by a helium jet mill is extremely effective for producing a sintered magnet having a uniform microstructure with the main phase grains being 1 μm or less in size.

Hereinafter described is the result of an experiment (Present Example 3) in which a flake-shaped lump of melt-spinning (MS) alloy with an average thickness of 15 μM having the composition shown in Table 3 was subjected to the HDDR and pulverizing processes in the same way as in the previous case of the lump of SC alloy to prepare an alloy powder, and a NdFeB system sintered magnet was produced from the obtained alloy powder by the same method as used in Present Examples 1 and 2. FIG. 15 shows a backscattered electron image taken at a fracture surface of the lump of MS alloy used in the present example. The average size of the crystal grains in this lump of MS alloy calculated from the backscattered electron image is 20 nm.

TABLE 3
Composition of Coarse Powder of Raw
Material Alloy (MS Alloy) Used in Present Example

| Nd | Pr | B | Cu | Al | Co | Fe |
|---|---|---|---|---|---|---|
| 24.1 | 7.81 | 1.01 | 0.10 | 0.24 | 0.92 | bal. |

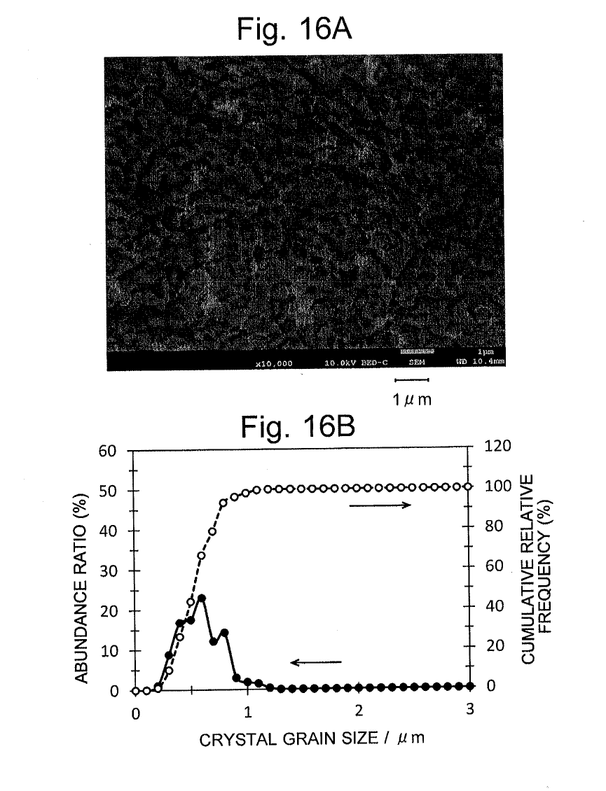

FIG. 16A shows an electron micrograph taken at a fracture surface of a lump obtained by performing the HDDR treatment on the lump of MS alloy (“the lump of alloy after HDDR”) in Present Example 3, while FIG. 16B shows the crystal grain size distribution of the crystal grains in this lump of alloy after HDDR determined by the previously mentioned image analysis. The average grain size (in circle-equivalent diameter) of this lump of alloy after HDDR calculated from these results is 0.53 μm, which is smaller than the previously described example of the SC alloy (0.60 μm).

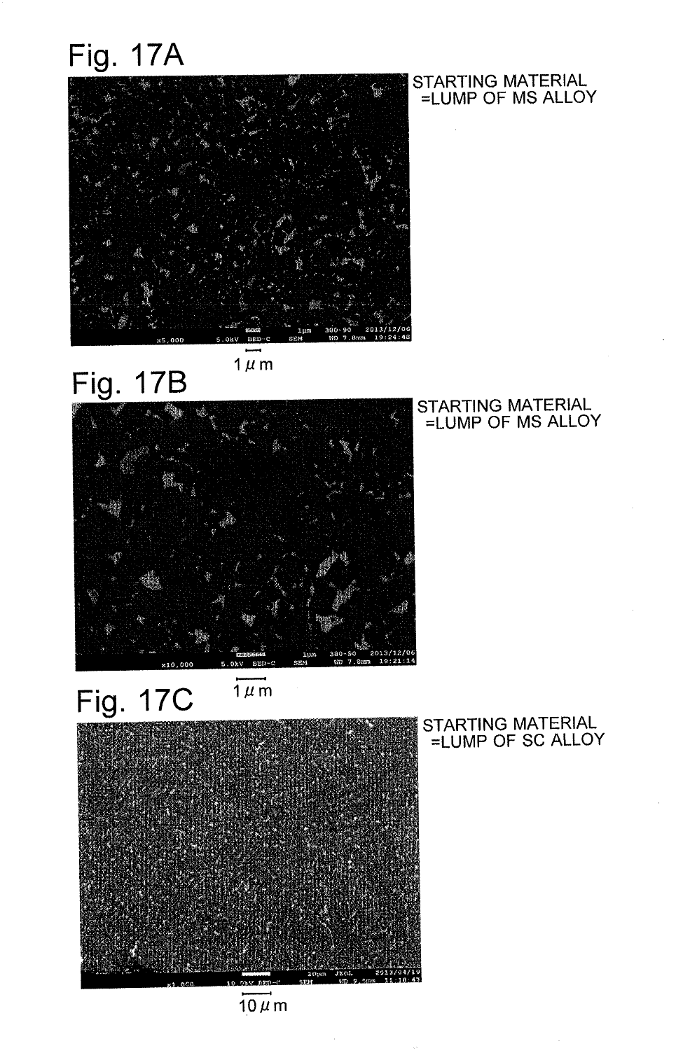

The two photographs in FIGS. 17A and 17B show backscattered electron images taken at different magnifications at a polished sectional surface of the lump of alloy after HDDR on the lump of MS alloy used as the lump of the raw material alloy. For comparison, the photograph in FIG. 17C shows a backscattered electron image taken at a polished sectional surface of the lump of alloy after HDDR on the previously mentioned lump of SC alloy used as the lump of the raw material alloy. The lump of alloy after HDDR on the lump of SC alloy used as the lump of the raw material alloy has the residue of the lamella structure of the rare-earth rich phase as indicated by the white portions, which corresponds to the structure of the lump of the raw material alloy shown in FIGS. 2A-2D. By contrast, in the backscattered electron images of the polished sectional surface of the lump of alloy after HDDR on the lump of MS alloy used as the raw material alloy, no structure that seems to be the lamella structure of the rare-earth rich phase can be observed; the rare-earth rich phase is evenly distributed in the form of dots surrounding each crystal grain. By using a coarse powder after HDDR obtained by pulverizing such a lump of alloy after HDDR with the rare-earth rich phase evenly distributed around each crystal grain, it is possible to produce an RFeB system sintered magnet in which the rare-earth rich phase is present with a high degree of uniformity around the main phase grains.

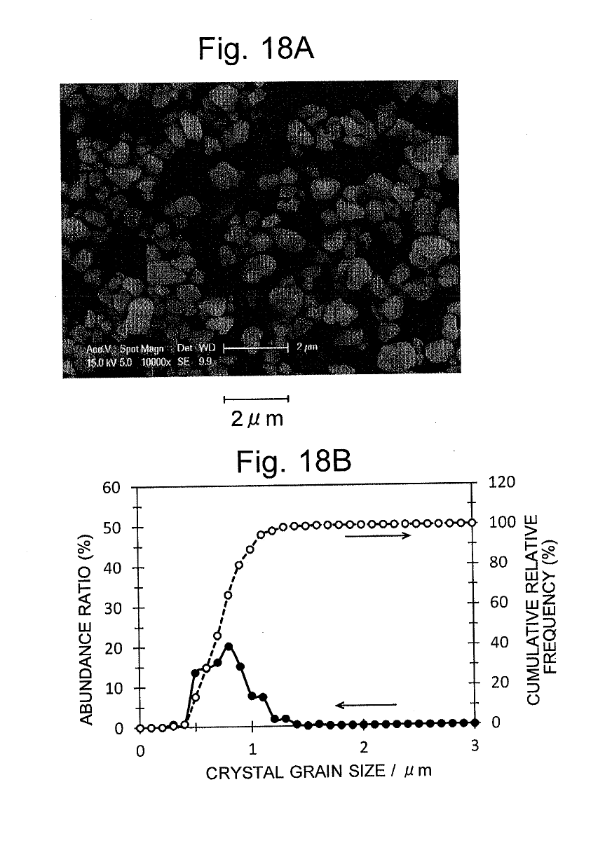

FIG. 18A shows an electron micrograph of a coarse powder after HDDR obtained by the hydrogen pulverization and jet-mill grinding of a lump of alloy after HDDR on a lump of MS alloy used as the lump of the raw material alloy, and FIG. 18B is the particle size distribution of this powder. FIG. 18A demonstrates that a coarse powder after HDDR which was almost free from non-pulverized polycrystalline particles was obtained. The average particle size of the alloy powder was 0.73 μm.

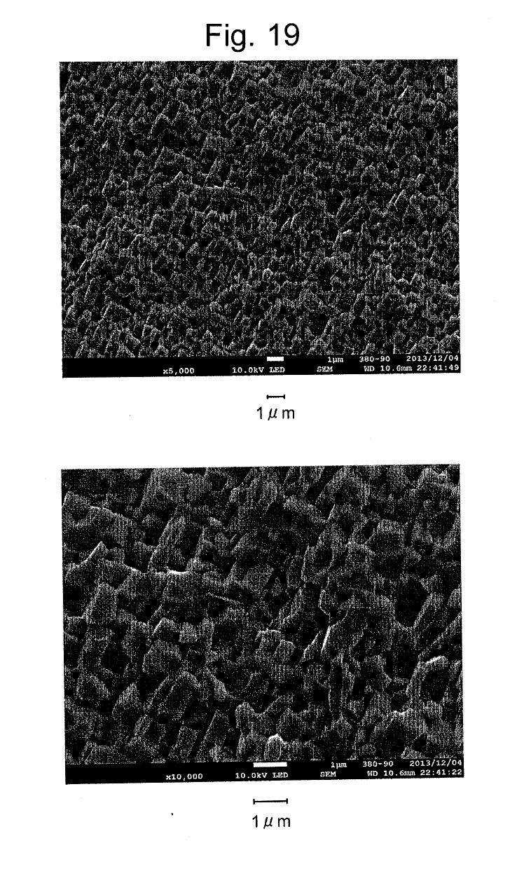

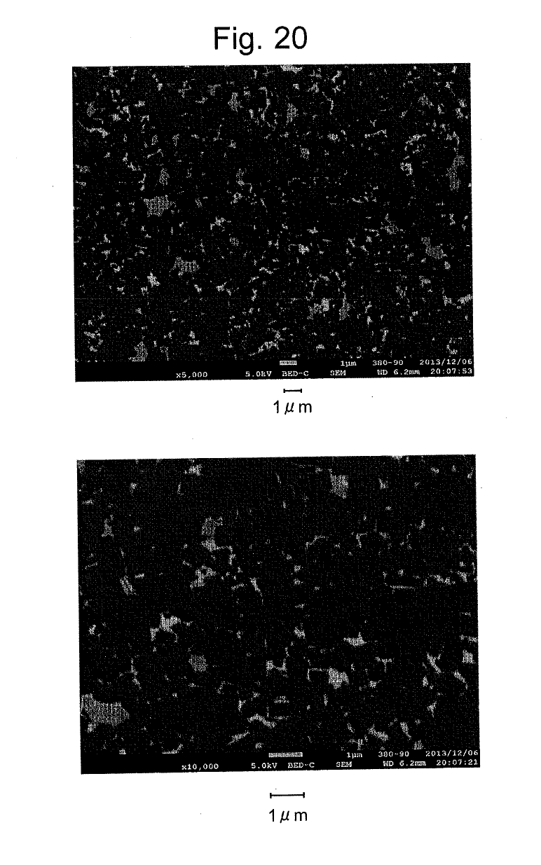

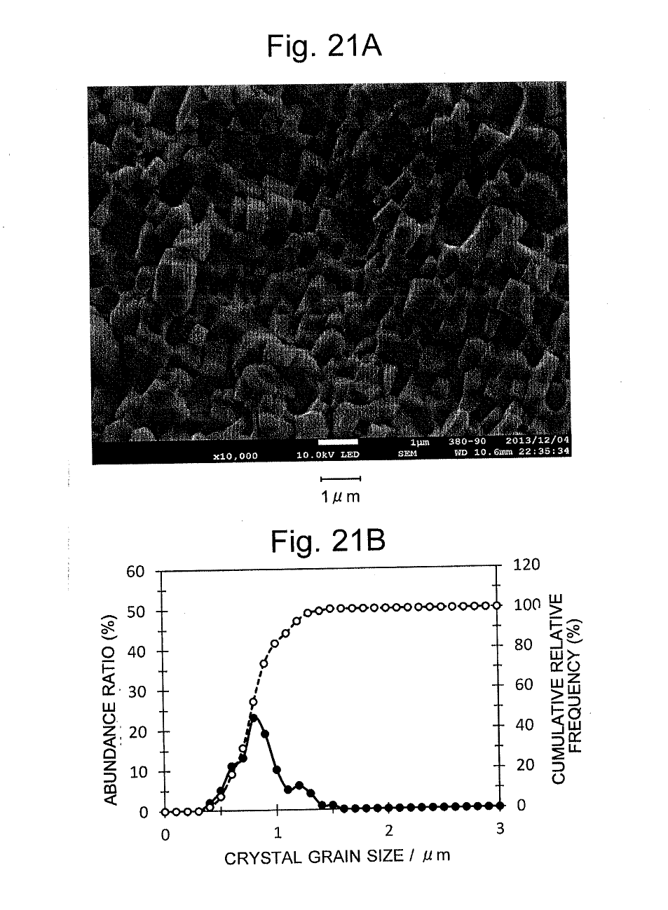

Using this coarse powder after HDDR, a NdFeB system sintered magnet was produced by the same method as applied in the production of the NdFeB system sintered magnet from the coarse powder after HDDR on the SC alloy used as the lump of the raw material alloy. FIG. 19 shows electron micrographs taken at a fracture surface of the obtained NdFeB system sintered magnet, and FIG. 20 shows electron micrographs at a polished sectional surface. In both of FIGS. 19 and 20, the lower micrograph was taken at a magnification twice as high as the upper one. Additionally, FIG. 21B shows the crystal grain size distribution determined by an image analysis based on an electron micrograph taken at the fracture surface (FIG. 21A, whose position on the fracture surface was different from FIG. 19). From the electron microscopes at the fracture surface and the crystal grain size distribution, the average grain size of the main phase grains in the produced NdFeB system sintered magnet was found to be 0.80 μm. In the micrographs taken at the polished sectional surface, white dot-like images indicating the rare-earth rich phase are distributed. Therefore, it is possible to conclude that the rare-earth rich phase is distributed with a high degree of uniformity even in this NdFeB system sintered magnet.

The alloy powder in the present examples cannot only be used in the previously described production method in which the powder is placed in a cavity of a mold and is subsequently oriented and sintered with no mechanical pressure applied, but also in a production method in which, after a powder placed in a cavity of a mold is oriented, the powder is compression-molded by a press machine and the obtained compression-molded compact is sintered.

The alloy powder in the present examples may also be used as the alloy powder of main phase materials in the “binary alloy blending technique”, a method for enhancing the coercivity of RFeB system sintered magnets, in which an alloy powder of main phase materials mainly composed of an alloy of R₂Fe₁₄B, and an alloy powder of rare-earth rich phase materials containing a higher amount of rare earth than the alloy of main phase materials are separately prepared, and a mixture of these powders is sintered. In the binary alloy blending technique, a light rare-earth element R^{L} consisting of Nd and/or Pr is used as the rare-earth element R contained in the alloy powder of main phase materials, while a heavy rare-earth element R^{H} consisting of one or more of the three rare-earth elements Tb, Dy and Ho is used as the rare-earth element contained in the alloy powder of grain boundary phase materials, whereby a structure with an increased concentration of R^{H} can be formed around the main phase grains. An RFeB system sintered magnet produced by this technique can have a higher level of magnetization than a magnet having the same composition but produced from a single alloy. Furthermore, by precisely mixing the alloy powder of main phase materials and that of rare-earth rich phase materials having smaller particle sizes, the rare-earth rich phase can be uniformly dispersed through the alloy powder of main phase materials, whereby the coercivity can be enhanced.

1. A method for producing an RFeB system sintered magnet including steps of preparing a shaped body oriented by a magnetic field and sintering the shaped body, wherein the shaped body is prepared using an alloy powder of an RFeB material having a particle size distribution with an average value of 1 μm or less in terms of a circle-equivalent diameter determined from a microscope image, the alloy powder obtained by pulverizing coarse particles having fine crystal grain, each coarse particle having crystal grains of the RFeB material formed inside, the crystal grains having a crystal grain size distribution with an average value of 1 μm or less in terms of the circle-equivalent diameter determined from a microscope image, and 90% by area or more of the grains being separated from each other.

2. The method for producing the RFeB system sintered magnet according to claim 1, wherein the shaped body is prepared by placing the alloy powder of the RFeB material in a cavity of a mold and orienting the alloy powder of the RFeB material by a magnetic field without applying a mechanical pressure to the alloy powder, and the shaped body is sintered without applying a mechanical pressure to the shaped body.

3. The method for producing the RFeB system sintered magnet according to claim 1, wherein the coarse particles having fine crystal grain used for producing the alloy powder of the RFeB material is obtained by treating a coarse powder of a raw material alloy by an HDDR method.

4. The method for producing the RFeB system sintered magnet according to claim 3, wherein the raw material alloy is an alloy produced by a melt spinning method.

5. The method for producing the RFeB system sintered magnet according to claim 1, wherein the coarse particles having fine grain are pulverized by a hydrogen pulverization method and further pulverized by a jet mill method using helium gas.

6. The method for producing the RFeB system sintered magnet according to claim 5, wherein the hydrogen pulverization treatment is performed at a temperature within a range of 100-300° C. for a period of time within a range of 1-10 hours.

7. The method for producing the RFeB system sintered magnet according to claim 1, wherein a powder made of a material containing a higher amount of rare earth than the alloy powder of the RFeB material is mixed in the alloy powder of the RFeB material.

8. An RFeB system sintered magnet, wherein grains of R₂Fe₁₄B forming a main phase have an average size of 1 μm or less and a degree of orientation of 95% or higher.

9. The RFeB system sintered magnet according to claim 8, wherein a ratio b/a calculated from a sectional BSE image including an axis of orientation of the RFeB system sintered magnet is equal to or greater than 0.45, where a denotes a length of a longest axis of a crystal grain and b denotes a length of an axis perpendicular to the longest axis.
